(19) United States
(12) Patent Application Publication
(10) Pub. No.: US 2017/0355384 A1
(43) Pub. Date: Dec. 14, 2017

(54) AUTONOMOUS BATTERY POD

(71) Applicant: Nofel Izz, Mississauga (CA)

(72) Inventor: Nofel Izz, Mississauga (CA)

(21) Appl. No.: 15/618,163

(22) Filed: Jun. 9, 2017

Related U.S. Application Data
(60) Provisional application No. 62/348,882, filed on Jun. 11, 2016.

(51) Int. Cl. B61C 3/02; B61C 17/06; B60L 11/18; H02J 7/00; H02K 7/18; H02J 7/14; H02J 7/34; B60F 1/02; B61D 15/00

(52) U.S. Cl. CPC B61C 3/02; B60F 1/02; B61C 17/06; B60L 11/1825; B60L 11/1842; B61D 15/00; H02K 7/1846; H02J 7/1415; H02J 7/34; H02J 7/0054; B60L 2200/26

(57) ABSTRACT

Disclosed is an autonomous battery pod. The autonomous battery pod for harnessing kinetic energy of rotating wheels to produce electrical energy while the autonomous battery pod is movably coupled with a train is provided. The autonomous battery pod includes a turbine adapted for producing electrical energy using harnessed kinetic energy through a plurality of extendable wheels connected with the turbine using a plurality of gearbox; and a plurality of batteries electrically coupled with the turbine, adapted for storing produced electrical energy using harnessed kinetic energy through the plurality of extendable wheels connected to the turbine.

### CROSS-REFERENCE TO RELATED APPLICATION

The present application is related to provisional patent application number 62/348882, filed on Jun. 11, 2016. The entire disclosure of the above patent application is hereby incorporated by reference.

### FIELD OF THE INVENTION

The present application generally relates to the field of energy production and distribution. Particularly, the application provides an autonomous battery pod. More particularly, the application provides an autonomous battery pod for harnessing kinetic energy of rotating wheels to produce electrical energy.

### BACKGROUND

With the advent of modern technology and industrial growth, energy consumption has also increased consequently by several folds. The modern technology has brought in phenomenal improvement in human life, however it also have impacted consumption pattern of energy resources. It is relevant to observe that the higher consumption of conventional energy resources, such as fossil fuel also results in high carbon dioxide emissions directly contributing in global warming.

There have been several efforts to identify and utilize alternative energy sources, such as kinetic energy in rotational motion, marine energy, tidal energy, hydroelectric, wind, geothermal and solar power and alike. Amongst others, harnessing kinetic energy from rotational motion of wheel of any automobile, and converting the same into electrical energy is one of the promising and sustainable alternative energy sources. However, energy production, storage and appropriate utilization of stored energy have always been challenging.

Prior art illustrates development of various tools, techniques, methods for harnessing kinetic energy from rotational motion of wheels of any automobile, and converting the same into electrical energy. Prior art discloses capturing kinetic energy from rotational motion of wheels of any automobile, wherein turbines are connected to moving wheels to convert the same into electrical energy. Some of the existing tools, systems related to harnessing kinetic energy from rotational motion of wheel known to us are as follows:

US20060005739A1 to General Electric Co discloses Railroad system comprising railroad vehicle with energy regeneration. Particularly, the US20060005739A1 discloses a self-powered railroad system (1700), in one embodiment, comprises a locomotive (1710), a control source (1715), and a plurality of load units (1720A-K and 1730A-G), some of which are railroad vehicles (1720A-K) comprising the components of railroad vehicle (1500) that provide for selective operation in a motoring mode, a coasting mode, or a dynamic braking mode. The self-powered railroad system may also comprise a control source and at least one railroad vehicle controlled by the control source, such as for coupling, uncoupling, and moving to or from a loading dock.

U.S. Pat. No. 8,136,454 to Norfolk Southern Corp discloses Battery-powered all-electric locomotive and related locomotive and train configurations. Particularly, the U.S. Pat. No. 8,136,454 discloses designs for a battery-powered, all-electric locomotive and related locomotive and train configurations. In one particular exemplary embodiment, a locomotive may be driven by a plurality of traction motors powered exclusively by a battery assembly which preferably comprises rechargeable batteries or other energy storage means. The locomotive carries no internal combustion engine on board and receives no power during operation from any power source external to the locomotive. A battery management system monitors and equalizes the batteries to maintain a desired state of charge (SOC) and depth of discharge (DOD) for each battery.

Prior art literature illustrates a variety of solution for harnessing kinetic energy of rotating wheels to produce electrical energy. However, the existing tools and systems described in the prior art fails to disclose autonomous battery unit movably coupled with a train for harnessing kinetic energy of rotating wheels to produce electrical energy. Prior art also fails to disclose autonomous battery unit which could embark on the railway track to be coupled with the train for harnessing kinetic energy of rotating wheels to produce electrical energy, store the produced electrical energy. Prior art also fails to disclose autonomous battery unit which could debark from the railway track and navigate automatically towards identified site to provide stored electrical energy.

In view of the above mentioned background, it is evident that, there is a need for an autonomous battery pod, which could harness kinetic energy of rotating wheels to produce electrical energy while the autonomous battery pod is movably coupled with a train. There is also a need for an autonomous battery pod which could embark on the railway track to be coupled with the train for harnessing kinetic energy of rotating wheels to produce electrical energy and store the produced electrical energy. There is also a need for an autonomous battery pod which could debark from the railway track and navigate automatically towards identified site to provide stored electrical energy. An autonomous battery pod is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide an autonomous battery pod.

Another objective is to provide an autonomous battery pod which could harness kinetic energy of rotating wheels to produce electrical energy while the autonomous battery pod is movably coupled with a train.

Another objective is to provide an autonomous battery pod which could embark on the railway track to be coupled with the train for harnessing kinetic energy of rotating wheels to produce electrical energy and store the produced electrical energy.

Another objective is to provide an autonomous battery pod which could debark from the railway track and navigate automatically towards identified site to provide stored electrical energy.

In accordance with one embodiment of the present invention, an autonomous battery pod (100) for harnessing kinetic energy of rotating wheels to produce electrical energy is provided. The autonomous battery pod (100) for harnessing kinetic energy of rotating wheels to produce electrical energy while the autonomous battery pod (100) is movably coupled with a train (118); the autonomous battery pod (100) comprises of a turbine (102) adapted for producing electrical energy using harnessed kinetic energy through a plurality of extendable wheels (104) connected with the turbine (102) using a plurality of gearbox (106); and a plurality of batteries (108) electrically coupled with the turbine (102),adapted for storing produced electrical energy using harnessed kinetic energy through the plurality of extendable wheels (104) connected with the turbine (102).

In accordance with one embodiment of the present invention, the autonomous battery pod provides the stored electrical energy in the plurality of batteries (108) to a power grid (120) or an electric vehicle charging station (122) while the autonomous battery pod (100) is disembarked the railway track and not coupled along with the train (118).

The above invention is provided as an autonomous battery pod for harnessing kinetic energy of rotating wheels to produce electrical energy but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: illustrates a perspective view of an autonomous battery pod, while the autonomous battery pod is movably coupled with a train, in accordance with one embodiment of the present invention;

FIG. 2: illustrates an exploded view of an autonomous battery pod, while the autonomous battery pod is movably coupled with a train, in accordance with one embodiment of the present invention; and

FIG. 3: illustrates an exploded view of an autonomous battery pod, while the autonomous battery pod is electrically coupled to the power grid or the electric vehicle charging station, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, an autonomous battery pod for harnessing kinetic energy of rotating wheels to produce electrical energy is provided while the autonomous battery pod is movably coupled with a train. The autonomous battery pod is provided for embarking on the railway track to be coupled with the train for harnessing kinetic energy of rotating wheels to produce electrical energy and store the produced electrical energy. The autonomous battery pod is provided for debarking from the railway track and navigating automatically towards identified site to provide stored electrical energy.

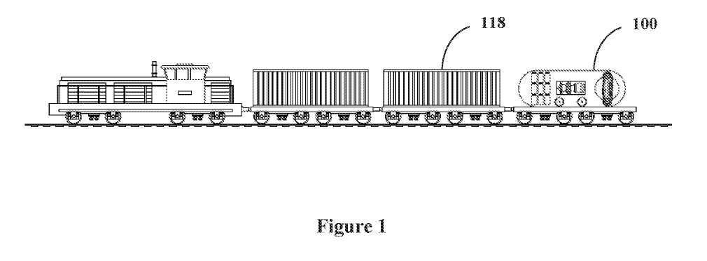

Referring to the FIG. 1 is a perspective view of an autonomous battery pod, while the autonomous battery pod is movably coupled with a train, in accordance with one embodiment of the present invention.

In accordance with one embodiment of the present invention, the autonomous battery pod (100) for harnessing kinetic energy of rotating wheels to produce electrical energy is provided. The autonomous battery pod (100) may harness kinetic energy of rotating wheels to produce electrical energy while the autonomous battery pod (100) is movably coupled with a train (118).

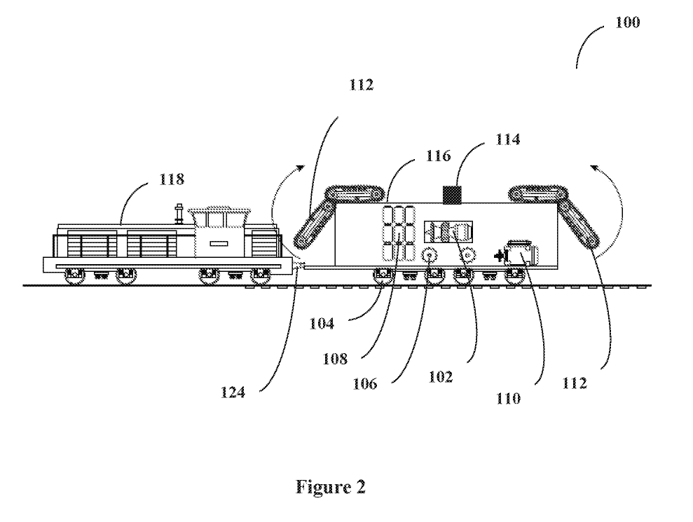

Referring to the FIG. 2 is an exploded view of an autonomous battery pod, while the autonomous battery pod is movably coupled with a train, in accordance with one embodiment of the present invention.

In accordance with one embodiment of the present invention, the autonomous battery pod (100) for harnessing kinetic energy of rotating wheels to produce electrical energy is provided. The autonomous battery pod (100) may harness kinetic energy of rotating wheels to produce electrical energy while the autonomous battery pod (100) is movably coupled with the train (118).The autonomous battery pod (100) may embark on the railway track on its own with the help of a GPS self-drive mechanism controlled by an autonomous navigation system (114).

In accordance with one embodiment of the present invention, the autonomous battery pod (100) comprises of a turbine (102), wherein the turbine (102) may be adapted for producing electrical energy using harnessed kinetic energy through a plurality of extendable wheels (104) connected with the turbine (102) using a plurality of gearbox (106).

In accordance with one embodiment of the present invention, the turbine (102) may be adapted for producing electrical energy using harnessed kinetic energy through the plurality of extendable wheels (104) connected with the turbine (102) using the plurality of gearbox (106) when the autonomous battery pod (100) is on a railway track while movably coupled along with the train (118).

In accordance with one embodiment of the present invention, the autonomous battery pod (100) further comprises of a plurality of batteries (108).The plurality of batteries (108) may be transported and recharged when the autonomous battery pod (100) is on a railway track while movably coupled along with the train (118).The plurality of batteries (108) may be electrically coupled with the turbine (102). The plurality of batteries (108) may be adapted for storing produced electrical energy using harnessed kinetic energy through the plurality of extendable wheels (104) connected with the turbine (102).

In accordance with one embodiment of the present invention, the autonomous battery pod (100) further comprises of an engine (110). The engine (110) may provide mobility to the autonomous battery pod (100) on a plurality of terrains with the help of a plurality of extendable continuous tracks (112), while the autonomous battery pod (100) is disembarked the railway track and not coupled along with the train (118). The plurality of extendable continuous tracks (112) may be lowered on a to the railway track to disembark the autonomous battery pod (100), and provide mobility to the autonomous battery pod (100) on the plurality of terrains using the engine (110). The plurality of extendable continuous tracks (112) may also provide mobility and navigation to the autonomous battery pod (100) in a plurality of directions while keeping the autonomous battery pod (100) stable when in motion.

In accordance with one embodiment of the present invention, the autonomous battery pod (100) further comprises of the autonomous navigation system (114). The autonomous navigation system (114) may be adapted for providing navigation to the autonomous battery pod (100) to embark on the railway track on its own to be coupled with the train for harnessing kinetic energy of rotating wheels to produce electrical energy and store the produced electrical energy; debark from the railway tracks and navigate automatically towards identified site to provide stored electrical energy with the help of the GPS self-drive mechanism controlled by the autonomous navigation system (114).

In accordance with one embodiment of the present invention, the autonomous battery pod (100) further comprises of an outer shell (116). The outer shell (116) may be adapted for providing secure cover to the turbine (102), the plurality of extendable wheels (104), the plurality of gearbox (106), the plurality of batteries (108), the engine (110), the plurality of extendable continuous tracks (112), and the autonomous navigation system (114).

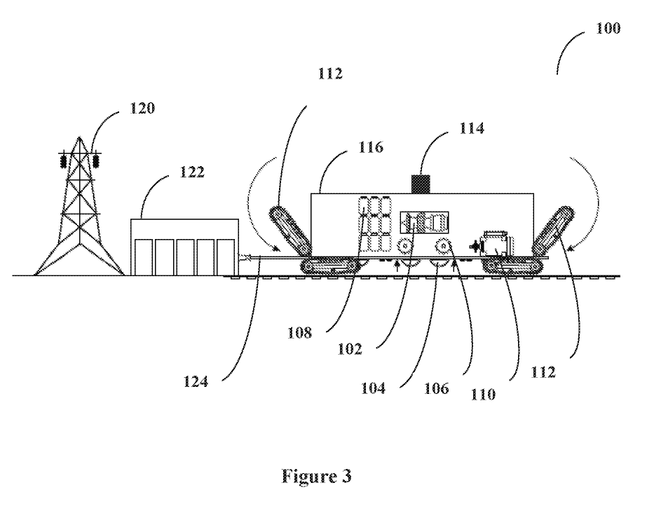

Referring to the FIG. 3 is an exploded view of an autonomous battery pod, while the autonomous battery pod is electrically coupled to the power grid or the electric vehicle charging station, in accordance with one embodiment of the present invention.

In accordance with one embodiment of the present invention, the autonomous battery pod (100) for harnessing kinetic energy of rotating wheels to produce electrical energy is provided. The autonomous battery pod (100) may embark on the railway track on its own to be coupled with the train for harnessing kinetic energy of rotating wheels to produce electrical energy and store the produced electrical energy. The autonomous battery pod may also debark from the railway tracks and navigate automatically towards identified site to provide stored electrical energy with the help of the GPS self-drive mechanism controlled by the autonomous navigation system (114).

In accordance with one embodiment of the present invention, the autonomous battery pod (100) may be adapted to provide the stored electrical energy in the plurality of batteries (108) to a power grid (120) or an electric vehicle charging station (122) while the autonomous battery pod (100) is disembarked the railway track and not coupled along with the train (118). The autonomous battery pod (100) may be disembarked the railway track autonomously. The autonomous battery pod (100) may navigate and connect autonomously with the nearest power grid (120) or the electric vehicle charging station (122) designated to dock the autonomous battery pod (100), with the help of the autonomous navigation system (114).The autonomous battery pod (100) may connect with the nearest power grid (120) to add electrical energy back to the power grid (120) or connect to the electric vehicle charging station (122) wherein a plurality of electric vehicles may be charged directly from the electric vehicle charging station (122). The autonomous battery pod (100) is electrically coupled to the power grid (120) or the electric vehicle charging station (122) with the help of a locking and power transfer mechanism (124) for providing the stored electrical energy in the plurality of batteries (108) to the power grid (120) or the electric vehicle charging station (122).

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. An autonomous battery pod (100) for harnessing kinetic energy of rotating wheels to produce electrical energy while the autonomous battery pod (100) is movably coupled with a train (118); wherein the autonomous battery pod (100) comprises of:
a. a turbine (102) adapted for producing electrical energy using harnessed kinetic energy through a plurality of extendable wheels (104) connected with the turbine (102) using a plurality of gearbox (106); and
b. a plurality of batteries (108) electrically coupled with the turbine (102),adapted for storing produced electrical energy using harnessed kinetic energy through the plurality of extendable wheels (104) connected with the turbine (102).

2. The autonomous battery pod (100) as claimed in claim 1, wherein the turbine (102) is adapted for producing electrical energy using harnessed kinetic energy through the plurality of extendable wheels (104) connected with the turbine (102) using the plurality of gearbox (106) when the autonomous battery pod (100) is on a railway track while movably coupled along with the train (118).

3. The autonomous battery pod (100) as claimed in claim 1, further comprises of an engine (110) to provide mobility to the autonomous battery pod (100) on a plurality of terrains with the help of a plurality of extendable continuous tracks (112), while the autonomous battery pod (100) is disembarked the railway track and not coupled along with the train (118).

4. The autonomous battery pod (100) as claimed in claim 3, wherein the plurality of extendable continuous tracks (112) are lowered onto the railway track to disembark the autonomous battery pod (100), and provide mobility to the autonomous battery pod (100) on the plurality of terrains using the engine (110).

5. The autonomous battery pod (100) as claimed in claim 3, wherein the plurality of extendable continuous tracks (112) provides mobility and navigation to the autonomous battery pod (100) in a plurality of directions while keeping the autonomous battery pod (100) stable when in motion.

6. The autonomous battery pod (100) as claimed in claim 1, further comprises of an autonomous navigation system (114) adapted for providing navigation to the autonomous battery pod (100) to travel to an assigned destination and return on the railway track to be coupled along with the train (118).

7. The autonomous battery pod (100) as claimed in claim 1, further comprises of an outer shell (116) adapted for providing secure cover to the turbine (102), the plurality of extendable wheels (104), the plurality of gearbox (106), the plurality of batteries (108), the engine (110), the plurality of extendable continuous tracks (112), and the autonomous navigation system (114).

8. The autonomous battery pod (100) as claimed in claim 1, further comprises of providing the stored electrical energy in the plurality of batteries (108) to a power grid (120) or an electric vehicle charging station (122) while the autonomous battery pod (100) is disembarked the railway track and not coupled along with the train (118).

9. The autonomous battery pod (100) as claimed in claim 8, wherein the autonomous battery pod (100) is electrically coupled to the power grid (120) or the electric vehicle charging station (122) with the help of a locking and power transfer mechanism (124) for providing the stored electrical energy in the plurality of batteries (108) to the power grid (120) or the electric vehicle charging station (122).
